(19) United States
(12) Patent Application Publication
(10) Pub. No.: US 2022/0236478 A1
(43) Pub. Date: Jul. 28, 2022

(54) PLASTIC OPTICAL FIBER, PRODUCTION METHOD FOR PLASTIC OPTICAL FIBER, AND PLASTIC OPTICAL FIBER CORD USING PLASTIC OPTICAL FIBER

(71) Applicant: NITTO DENKO CORPORATION, Ibaraki-shi, Osaka (JP)

(72) Inventors: Kazumasa Okada, Ibaraki-shi (JP); Kentarou Takeda, Ibaraki-shi (JP); Nobuhiro Fukuura, Ibaraki-shi (JP)

(73) Assignee: NITTO DENKO CORPORATION, Ibaraki-shi, Osaka (JP)

(21) Appl. No.: 17/610,528

(22) PCT Filed: Apr. 27, 2020
(86) PCT No.: PCT/JP2020/017897

§ 371 Date: Nov. 11, 2021

(30) Foreign Application Priority Data
May 13, 2019 (JP) 2019-090391

(51) Int. Cl. G02B 6/02; G02B 6/036

(52) U.S. Cl. CPC G02B 6/02033; G02B 6/036

(57) ABSTRACT

Provided is a plastic optical fiber, which is suppressed from causing cracks even when used for a long period of time in a state of being subjected to an external force. A plastic optical fiber (10) of the present invention includes: a core portion (12); a cladding portion (14) arranged on an outer periphery of the core portion (12); and an over-cladding portion (16) arranged on an outer periphery of the cladding portion (14), wherein the over-cladding portion (16) has a birefringence Δn of 0.002 or more.

### TECHNICAL FIELD

The present invention relates to a plastic optical fiber and a method of producing the plastic optical fiber, and a plastic optical fiber cord using the plastic optical fiber.

### BACKGROUND ART

As an optical transmitter, a plastic optical fiber (hereinafter sometimes referred to as “POF”) in which both a core and a cladding include plastic is attracting attention. The POF is typically composited with a fiber tension member, such as aramid fibers, covered with a soft vinyl chloride (PVC) resin or the like, and laid and used in the form of a cord or a cable. However, when the POF is used for a long period of time in a state of being subjected to an external force in a diametrical direction of a cross-section perpendicular to a lengthwise direction (for example, in a bent state or in a state of being tightly bound to other wires in cable formation), cracks occur in some cases.

### CITATION LIST

### Patent Literature

[PTL 1] JP 05-11128 A

[PTL 2] JP 2000-147272 A

[PTL 3] WO 2004/102243 A1

[PTL 4] JP 2005-326502 A

[PTL 5] JP 2007-199420 A

[PTL 6] JP 2011-232726 A

### SUMMARY OF INVENTION

### Technical Problem

The present invention has been made to solve the above-mentioned problem of the related art, and a primary object of the present invention is to provide a plastic optical fiber, which is suppressed from causing cracks even when used for a long period of time in a state of being subjected to an external force.

### Solution to Problem

According to one aspect of the present invention, there is provided a plastic optical fiber, including: a core portion; a cladding portion arranged on an outer periphery of the core portion; and an over-cladding portion arranged on an outer periphery of the cladding portion, wherein the over-cladding portion has a birefringence Δn of 0.002 or more.

In one embodiment, the over-cladding portion contains a polycarbonate-based resin.

In one embodiment, the plastic optical fiber is prevented from causing cracks after having been left for 1 week in a state of being bent with a radius of curvature of 20 mm and being brought into contact with polyethylene glycol or a long-chain aliphatic hydrocarbon.

According to another aspect of the present invention, there is provided a method of producing the above-mentioned plastic optical fiber. The production method includes: forming a preform; and stretching the preform, wherein a stretching ratio of the stretching is 1.2 times or less, and a stretching temperature thereof is less than a glass transition temperature of the over-cladding portion.

According to still another aspect of the present invention, there is provided a plastic optical fiber cord. The plastic optical fiber cord includes the plastic optical fiber.

### Advantageous Effects of Invention

According to the present invention, the plastic optical fiber, which is suppressed from causing cracks even when used for a long period of time in a state of being subjected to an external force, can be achieved by controlling the aligned state of the over-cladding portion for covering the cladding portion to set the birefringence Δn to a predetermined value or more in the plastic optical fiber.

### BRIEF DESCRIPTION OF DRAWINGS

FIG. 1 is a schematic sectional view of a surface perpendicular to a lengthwise direction of a plastic optical fiber according to one embodiment of the present invention.

FIG. 2 is a schematic sectional view of a surface perpendicular to a lengthwise direction of a plastic optical fiber cord according to one embodiment of the present invention.

### DESCRIPTION OF EMBODIMENTS

Now, embodiments of the present invention are described. However, the present invention is not limited to these embodiments.

A. Plastic Optical Fiber

### A-1. Overview of Plastic Optical Fiber

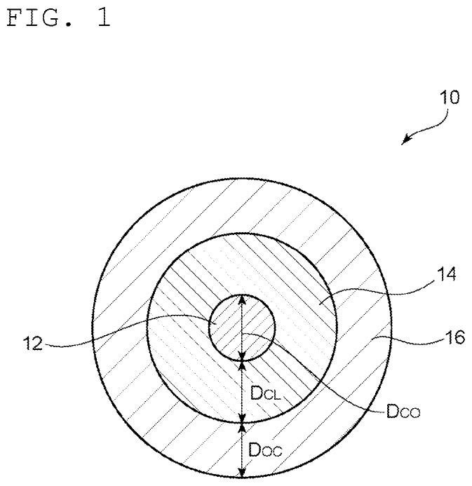

FIG. 1 is a schematic sectional view of a surface perpendicular to a lengthwise direction of a plastic optical fiber according to one embodiment of the present invention. A plastic optical fiber (POF) 10 of the illustrated example includes a core portion 12, a cladding portion 14 arranged on an outer periphery of the core portion 12, and an over-cladding portion 16 arranged on an outer periphery of the cladding portion 14. Typically, the cladding portion 14 covers the entire outer periphery of the core portion 12, and the over-cladding portion 16 covers the entire outer periphery of the cladding portion 14. The POF may be a step index type (SI type) or a refractive index distribution (Graded Index) type (GI type). In addition, the POF may be in a multimode or a single mode.

In the embodiment of the present invention, the over-cladding portion 16 has a birefringence Δn of 0.002 or more. A plastic optical fiber, which is suppressed from causing cracks even when used for a long period of time in a state of being subjected to an external force, can be achieved by setting the birefringence Δn of the over-cladding portion to 0.002 or more. More details are as described below. The POF is typically composited with a fiber tension member (for example, aramid fibers), covered with a soft PVC resin or the like, and used in the form of a cord or a cable. Herein, the fiber tension member contains a fiber sizing agent, and hence cracks may occur in the over-cladding portion due to the influence of the fiber sizing agent. Cracks typically occur due to the long-term use, and are particularly remarkable in a part in which an external force is applied in a diametrical direction (for example, a bent portion or a portion firmly bound to other wires in cable formation). As the fiber sizing agent, there are typically given polyether (for example, polyethylene glycol) and a long-chain aliphatic hydrocarbon. When the aligned state of molecules in a fiber lengthwise direction of (a material for forming) the over-cladding portion is enhanced until the birefringence Δn of the over-cladding portion reaches 0.002 or more, the resistance to the fiber sizing agent can be improved. As a result, cracks can be suppressed (hereinafter, such characteristic is sometimes referred to as “solvent crack resistance”). In particular, cracks can be satisfactorily suppressed even when the POF is used for a long period of time in a state of being subjected to an external force. Although not theoretically clear, the foregoing can be inferred as described below. When an oil component, such as the above-mentioned fiber sizing agent, is brought into contact with the POF under a state in which a stress acts on the POF, the oil component is absorbed from the surface of the POF, with the result that small cracks are liable to occur in a sectional direction of the POF. It is conceived that the oil component enters the POF through the cracks, and the cracks propagate in the sectional direction of the POF. When the aligned state of the molecules of the over-cladding portion is enhanced in the lengthwise direction of the POF, the occurrence of cracks in the sectional direction of the POF is suppressed. Further, even when small cracks occur, molecular chains of the material for forming the over-cladding portion are aligned in a direction perpendicular to a propagating direction of the cracks, and hence the propagation of the cracks can be suppressed. Similarly, a plasticizer (for example, tris(2-ethylhexyl) trimellitate) contained in a soft PVC resin or the like of a covering material may migrate through gaps of the fiber tension member to be brought into contact with the POF, to thereby cause cracks. However, even in such a case, cracks can be suppressed. The birefringence Δn may be obtained by deriving an in-plane retardation value Δnd of the over-cladding portion by a peak valley method and dividing the retardation value Δnd by a thickness D_{oc} of the over-cladding portion.

In one embodiment, the POF is prevented from causing cracks after having been left for 1 week in a state of being bent with a radius of curvature of 20 mm and being brought into contact with polyethylene glycol or a long-chain aliphatic hydrocarbon. As described above, when the aligned state of the molecules in the fiber lengthwise direction of (the material for forming) the over-cladding portion is enhanced until the birefringence Δn of the over-cladding portion reaches 0.002 or more, such solvent crack resistance can be achieved. The radius of curvature of the bending is preferably 20 mm or less as described above, more preferably 15 mm or less, still more preferably 10 mm or less. The lower limit of the radius of curvature may be, for example, 3 mm. It is preferred that the period during which cracks do not occur be as long as possible. A specific example of the period is preferably 1 week or more as described above, more preferably 2 weeks or more, still more preferably 1 month or more. According to the embodiment of the present invention, a POF in which cracks do not occur even after an elapse of such a long period of time can be actually obtained. A substance that is brought into contact with the POF is typically a substance that may be used as a fiber sizing agent. As specific examples of such a substance, there are given a water-soluble epoxy resin, an imidazole silane-based compound, and an unsaturated carboxylic acid ester in addition to the above-mentioned polyethylene glycol and long-chain aliphatic hydrocarbon. As used herein, the “long-chain aliphatic hydrocarbon” refers to an aliphatic hydrocarbon having 12 or more carbon atoms. In addition, as used herein, the “long-chain aliphatic hydrocarbon” also encompasses a long-chain aliphatic hydrocarbon ester of a carboxylic acid. Specific examples of the long-chain aliphatic hydrocarbon are described in, for example, JP 2009-74229 A and JP 11-335972 A, the description of which is incorporated herein by reference. As a typical example of the long-chain aliphatic hydrocarbon, there is given diisononyl phthalate.

Constituent elements of the POF are specifically described below.

### A-2. Core Portion

The core portion 12 may include any appropriate material. The core portion typically includes an acrylic resin. In one embodiment, the core portion includes an acrylic resin containing trichloroethyl methacrylate (hereinafter sometimes referred to as “TCEMA”) as a main component of monomer components. In this case, the acrylic resin may be obtained by polymerizing the monomer components containing TCEMA, and methyl methacrylate (hereinafter sometimes referred to as “MMA”), methyl acrylate (hereinafter sometimes referred to as “MA”), N-cyclohexylmaleimide (hereinafter sometimes referred to as “N-cHMI”), cyclohexyl acrylate (hereinafter sometimes referred to as “cHA”), trichloroethyl acrylate (hereinafter sometimes referred to as “TCEA”), isobornyl acrylate (hereinafter sometimes referred to as “iBoA”), and/or cyclohexyl methacrylate (hereinafter sometimes referred to as “cHMA”) serving as copolymerization components. Herein, the “main component” means the heaviest component among the monomer components. TCEMA may be contained in the monomer components in a proportion of preferably 70 wt % or more, more preferably from 80 wt % to 100 wt %. TCEMA may be contained in the monomer components in a proportion of from 80 wt % to 95 wt %. Through use of TCEMA in a proportion of 70 wt′ or more in the monomer components, a core portion, which is excellent in transparency and may increase a communication distance, can be formed.

The core portion 12 is formed of the above-mentioned acrylic resin serving as a main constituent component. Herein, the “main constituent component” means the heaviest component among all the components for forming the core portion, and means that the core portion 12 may contain other resins, dopants to be described later, additives, and the like in addition to the main constituent component.

The core portion 12 preferably contains a dopant. When the dopant is incorporated, a refractive index distribution can be imparted to the core portion. That is, a GI type POF can be obtained. When the refractive index distribution is imparted to the core portion, a communication speed can be improved. In order to impart the refractive index distribution, it may be useful to adjust the concentration distribution of the dopant in the core portion. The dopant is preferably a compound, which is compatible with the acrylic resin serving as the main constituent component of the core portion and has a refractive index different from that of the acrylic resin. Through use of a compound having satisfactory compatibility, scattering loss can be suppressed as much as possible without occurrence of turbidity in the core portion, and the communication distance can be increased. Typical examples of the dopant having a high refractive index include: sulfur compounds, such as diphenyisulfone (DPSO) and diphenyisulfone derivatives (e.g., diphenyisulfone chlorides, such as 4,4′-dichlorodiphenylsulfone and 3,3′,4,4′-tetrachlorodiphenylsulfone), diphenyl sulfide (DPS), diphenyl sulfoxide, dibenzothiophene, and dithiane derivatives; phosphate compounds, such as triphenyl phosphate (TPP) and tricresyl phosphate; benzyl benzoate; benzyl n-butyl phthalate; diphenyl phthalate; biphenyl; and diphenylmethane. A typical example of the dopant having a low refractive index is tris-2-ethylhexyl phosphate (TOP). Those compounds may be used alone or in combination thereof. Of those, DPSO, DPS, TPP, and TOP are preferred. Those dopants can improve the communication speed while maintaining the transparency and heat resistance of the core portion. Of those, DPS, TPP, and TOP are more preferred. DPS has the effect of suppressing thermal decomposition of an acrylic resin containing TCEMA as a main component (main constituent unit), and TPP and TOP can capture hydrochloric acid desorbed by a heat load.

The content of the dopant in the core portion may be appropriately set in accordance with the desired configuration of the POE′, the constituent materials and desired refractive index of the core portion, the constituent materials and desired refractive index of the cladding portion, and the like. The content of the dopant may be, for example, from 0.1 part by weight to 25 parts by weight, may be, for example, from 1 part by weight to 20 parts by weight, or may be, for example, from 2 parts by weight to 15 parts by weight with respect to 100 parts by weight of the constituent materials of the core portion.

Details of the acrylic resin, the dopant, and the like for forming the core portion are described in JP 2011-232726 A, the description of which is incorporated herein by reference.

A refractive index N_{CO} of the core portion is preferably from 1.3 to 1.7, more preferably from 1.4 to 1.6. When the refractive index of the core portion falls within such ranges, it is easy to make the difference from the refractive index of the cladding portion appropriate.

A diameter D_{CO} of the core portion is preferably from 10 μm to 2,000 μm, more preferably from 30 μm to 1,000 μm. When the diameter of the core portion falls within such ranges, there is an advantage in that the degree of freedom of alignment when a light source and the POF are connected is large.

### A-3. Cladding Portion

The cladding portion 14 may include any appropriate material. The cladding portion typically includes an acrylic resin. In one embodiment, the cladding portion includes an acrylic resin containing MMA as a monomer component. In this case, the acrylic resin may be obtained by polymerizing monomer components containing MMA, and TCEMA, MA, N-cHMI, cHA, TCEA, iBoA, and/or cHMA serving as copolymerization components. MMA may be contained in the monomer components in a proportion of preferably 20 wt % or more, more preferably from 30 wt % to 100 wt %. MMA may be contained in the monomer components in a proportion of from 30 wt % to 95 wt %. Through use of MMA in a proportion of 20 wt % or more in the monomer components, a cladding portion, which is excellent in flexibility and has a refractive index appropriately smaller than that of the core portion, can be formed. As a result, the bending loss of the POF can be suppressed, and the communication speed can be improved.

The cladding portion 14 may contain a dopant. The dopant is as described in the section A-2 regarding the core portion. When the cladding portion contains the dopant, the content thereof may be appropriately set in accordance with the desired configuration of the POF, the constituent materials and desired refractive index of the cladding portion, the constituent materials and desired refractive index of the core portion, and the like. The content of the dopant may be, for example, from 0 parts by weight to 25 parts by weight, may be, for example, from 0 parts by weight to 20 parts by weight, or may be, for example, from 0 parts by weight to 15 parts by weight with respect to 100 parts by weight of the constituent materials of the cladding portion.

Details of the acrylic resin, the dopant, and the like for forming the cladding portion are described in JP 2011-232726 A, the description of which is incorporated herein by reference.

A refractive index N_{CL} of the cladding portion is typically smaller than the refractive index N_{CO} of the core portion. The difference (N_{CO}—N_{NL}) between the refractive index N_{CL} of the cladding portion and the refractive index N_{CO} of the core portion is preferably 0.002 or more, more preferably 0.005 or more. The upper limit of the difference may be, for example, 0.02. When the difference falls within such ranges, there is an advantage in that the quantity of the light passing from the core portion to the outside of the cladding portion can be reduced at the time of optical transmission.

A thickness D_{CL} of the cladding portion 14 is preferably from 2 μm to 300 μm, more preferably from 5 μm to 250 μm. When the thickness of the cladding portion falls within such ranges, the light to be used for communication can be satisfactorily confined in the core portion, and hence a POF excellent in light transmission efficiency can be achieved. Further, the POF itself can be made thin, and hence there is an advantage also from the viewpoints of bendability and a weight reduction.

### A-4. Over-Cladding Portion

The birefringence Δn of the over-cladding portion 16 is 0.002 or more as described above, preferably 0.003 or more, more preferably 0.004 or more, still more preferably 0.005 or more. The upper limit of the birefringence Δn of the over-cladding portion 16 may be, for example, 0.020. When the birefringence of the over-cladding portion is set to fall within such ranges, excellent solvent crack resistance can be achieved as described above. Further, when the upper limit of the birefringence is set to the above-mentioned value, breakage of the core portion and the cladding portion can be satisfactorily suppressed. Such birefringence may be achieved by enhancing the aligned state of the molecules in the fiber lengthwise direction of (the material for forming) the over-cladding portion. Specifically, such an over-cladding portion may be formed by performing specific stretching treatment as described in the section B to be described later.

The over-cladding portion 16 may include any appropriate material as long as the above-mentioned birefringence can be exhibited. Preferably, the over-cladding portion may include a material having excellent mechanical characteristics and excellent adhesiveness with respect to the cladding portion in addition to the above-mentioned birefringence. As a specific example of such a material, there is given a polycarbonate-based resin. When the over-cladding portion includes the polycarbonate-based resin, a POF excellent in transparency, heat resistance, and flexibility can be achieved. The polycarbonate-based resin is preferably a modified polycarbonate-based resin composited with polyester. This is because the modified polycarbonate-based resin composited with polyester is excellent in chemical resistance and flowability.

The thickness D_{oc} of the over-cladding portion 16 is preferably from 50 μm to 500 μm, more preferably from 70 μm to 300 μm. When the thickness of the over-cladding portion falls within such ranges, the core portion and the cladding portion can be satisfactorily protected, and the flexibility and plasticity required in the POF can be satisfied.

B. Method of Producing Plastic Optical Fiber

The POF described in the section A may be produced, for example, by forming a preform in advance and stretching the preform. As used herein, the “preform” is an unstretched POF including a core portion, a cladding portion, and an over-cladding portion. The preform may be obtained by any appropriate method. As typical examples of a method of producing a preform, there are given a melt extrusion method, a melt spinning method, a melt extrusion dopant diffusion method, and a rod-in-tube method. In those methods, procedures that are well-known in the art may be adopted. For example, according to the melt extrusion method, a material for forming the core portion, a material for forming the cladding portion, and a material for forming the over-cladding portion are each supplied to a concentric three-layer mold and melt-extruded at a predetermined temperature. Thus, a preform having a sectional structure as illustrated in FIG. 1 can be produced. Further, for example, according to another melt extrusion method, a material for forming the core portion and a material for forming the cladding portion are each supplied to a concentric two-layer mold and melt-extruded at a predetermined temperature. Further, through use of another two-layer mold, a material for forming the over-cladding portion, which is separately melt-extruded to the outside of a flow path of melts of the core portion and the cladding portion, is joined. Thus, a preform having a sectional structure as illustrated in FIG. 1 can be produced. In the melt spinning method, a spinning nozzle (typically, a three-layer nozzle) may be used instead of the mold.

Next, the obtained preform is cooled to a predetermined temperature without being substantially stretched. The cooling may be performed through use of any appropriate cooling means, or may be natural cooling (radiational cooling). The predetermined temperature is preferably less than the glass transition temperature (Tg) of the over-cladding portion, more preferably from (Tg-60° C.) to (Tg-10° C.), still more preferably from (Tg-50° C.) to (Tg-20° C.). When the constituent materials of the core portion, the cladding portion, and the over-cladding portion, and the stretching ratio and the stretching speed are appropriately adjusted, an over-cladding portion having the desired birefringence Δn may be formed in some cases even when the stretching temperature is more than the Tg of the over-cladding portion.

Next, the preform is stretched at the predetermined temperature. In general, stretching at a temperature less than the Tg is substantially difficult. However, according to the embodiment of the present invention, the preform can be stretched at up to about 1.2 times by: appropriately selecting the constituent materials of the core portion, the cladding portion, and the over-cladding portion (thus, the Tg of each of the core portion, the cladding portion, and the over-cladding portion); and adjusting a stretching speed to be described later. Further, the aligned state (as a result, the birefringence Δn) of the over-cladding portion can be significantly enhanced by stretching at such a low stretching ratio. This is an unexpectedly excellent effect that cannot be imagined from the common general technical knowledge in the art of polymer processing. As a result, a POF excellent in solvent crack resistance can be obtained.

The stretching ratio is typically 1.2 times or less as described above, preferably from 1.02 times to 1.18 times, more preferably from 1.05 times to 1.15 times, still more preferably from 1.08 times to 1.12 times. According to the embodiment of the present invention, when the constituent materials of the core portion, the cladding portion, and the over-cladding portion, the stretching temperature, and the stretching speed to be described later are appropriately combined, the aligned state (as a result, the birefringence Δn) of the over-cladding portion can be significantly enhanced even at such a low stretching ratio. As a result, a POF excellent in solvent crack resistance can be obtained. When the constituent materials of the core portion, the cladding portion, and the over-cladding portion, and the stretching temperature are appropriately adjusted, an over-cladding portion having the desired birefringence Δn may be formed in some cases even when the stretching ratio is more than 1.2 times. Alternatively, an over-cladding portion having the desired birefringence Δn may be formed by stretching a preform at the time of the formation of the preform instead of stretching a formed preform. Specifically, an over-cladding portion having the desired birefringence Δn may be formed by stretching molten yarn extruded with a large diameter until the desired diameter is obtained simultaneously with the melt spinning. In this case, stretching of the formed preform may be omitted. In addition, the stretching ratio with respect to the extruded molten yarn is significantly large. For example, when the extruded diameter at the time of melting is 10 mm, and the diameter of a preform to be formed is 400 μm, the stretching ratio with respect to the extruded molten yarn is 625 times.

The stretching speed is preferably from 0.05 m/min to 0.20 m/min, more preferably from 0.07 m/min to 0.15 m/min, still more preferably from 0.08 m/min to 0.12 m/min. With such a stretching speed, the above-mentioned desired stretching can be achieved. Such a stretching speed is significantly lower than usual, and through combination of such a low stretching speed with the above-mentioned stretching temperature less than the Tg, a POF including an over-cladding portion having the desired birefringence Δn can be produced without breakage of the preform.

As described above, the POF may be produced. A series of operations from formation of a preform to stretching may be performed continuously, or a preform once stored may be subjected to stretching.

C. Plastic Optical Fiber Cord

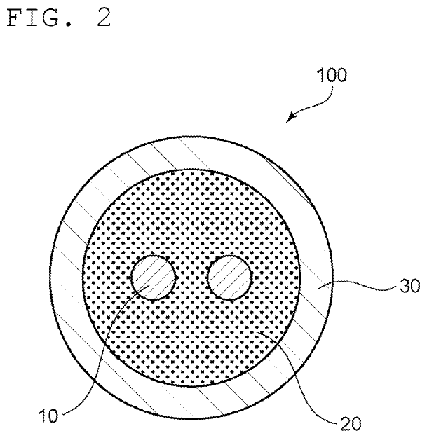

The POF described in the sections A and B may be used for a plastic optical fiber cord. Accordingly, the embodiment of the present invention also encompasses a plastic optical fiber cord. FIG. 2 is a schematic sectional view of a surface perpendicular to a lengthwise direction of a plastic optical fiber cord (hereinafter sometimes referred to as “POF cord”) according to one embodiment of the present invention. A POF cord 100 of the illustrated example includes one or a plurality of (two in the illustrated example) POFs 10, a fiber tension member 20 arranged so as to surround the outer periphery of each of the POFs 10, and a covering portion 30 for covering the fiber tension member 20. The POF is the POF described in the sections A and B.

Examples of fibers for forming the fiber tension member 20 include aramid fibers, polyethylene terephthalate (PET) fibers, carbon fibers, and glass fibers. Of those, aramid fibers are preferred. This is because the fibers are excellent in rigidity, plasticity, and property of preventing breakage due to repeated bending. The fibers for forming the fiber tension member preferably have a chord modulus measured by ASTM-D885M of 100 GPa or more.

The covering portion 30 typically includes a resin that is chemically stable with respect to the fiber sizing agent. Examples of the resin include a soft PVC resin, an acrylic resin, a silicone-based resin, a silicone-based sealing agent, and an epoxy-based resin. The thickness of the covering portion may be, for example, from 10 μm to 50 μm.

### EXAMPLES

Now, the present invention is specifically described by way of Examples. However, the present invention is not limited by these Examples. Measurement methods for characteristics are as described below.

(1) Birefringence Δn of Over-Cladding Portion

POFs obtained in Examples and Comparative Examples were each sandwiched between two slide glasses, and the gap was filled with matching oil having the same refractive index as that of the over-cladding portion to obtain a test sample. A pair of analyzers was prepared and arranged so as to obtain the configuration “analyzer/test sample/analyzer.” In this case, the pair of analyzers was arranged so that the pair of analyzers had a crossed Nicols state and the optical axis of each of the analyzers was 45° with respect to the lengthwise direction of the POF. In this state, the spectral transmittance of a portion close to a central part of the POF of the over-cladding portion was measured from above the test sample through use of a microspectrophotometer (manufactured by Craic Technologies, product name: “308PV”). An in-plane retardation value Δnd of the over-cladding portion was derived from the wavelengths of the peak and valley of a spectral spectrum (peak valley method). The birefringence Δn of the over-cladding portion was calculated by dividing the obtained in-plane retardation value Δnd by the thickness D_{oc} of the over-cladding portion.

(2) Solvent Crack Resistance

Both ends of each of the POFs obtained in Examples and Comparative Examples were fixed under a state in which the POF was bent with a radius of curvature of 20 mm. Diisononyl phthalate (DINP) was added dropwise to the bent portion, and the time required for cracks to occur was examined while the state in which DINP was present in the bent portion was maintained.

### Example 1

Purified TCEMA and DPS serving as a dopant were mixed at a weight ratio of TCEMA:DPS=100:4. Further, di-t-butyl peroxide serving as a polymerization initiator and n-lauryl mercaptan serving as a chain transfer agent were added so that the concentrations in the total weight were 0.03 wt % and 0.2 wt %, respectively. Then, the resultant was filtered with a membrane filter having a pore diameter of 0.2 μm. This mixed solution was degassed under reduced pressure while ultrasonic waves were applied thereto, and then, the solution was placed in a polymerization vessel. The monomers were polymerized over 40 hours while the temperature of the polymerization vessel was maintained at 120° C. Thus, a core portion rod (outer diameter: 30 mm) was obtained.

Meanwhile, purified TCEMA and MMA were mixed at a weight ratio of TCEMA:MMA=20:80. Further, benzoyl peroxide serving as a polymerization initiator and n-butyl mercaptan serving as a chain transfer agent were added so that the concentrations in the total weight were 0.5 wt % and 0.3 wt %, respectively. Then, the resultant was filtered with a membrane filter having a pore diameter of 0.2 μm. This mixed solution was degassed under reduced pressure while ultrasonic waves were applied thereto, and then, the solution was placed in a polymerization vessel. The monomers were polymerized over 40 hours while the temperature of the polymerization vessel was maintained at 120° C. Thus, a cladding portion rod (outer diameter: 30 mm) was obtained.

The obtained core portion rod and cladding portion rod were formed into a laminated multi-layer shape of a core portion and a cladding portion through use of separate extrusion molding machines and a two-layer mold connected thereto. Further, the resultant was passed through a heating flow path for a certain period of time so that the dopant contained in the core portion was diffused into the cladding portion. Further, XYLEX X7300CL [product name, manufactured by SABIC Innovative Plastics, polyester-modified polycarbonate] (hereinafter sometimes simply referred to as “PC”), which was an over-cladding material, was melted with another extrusion molding machine, and was joined with a flow path of melts of the core portion and the cladding portion through use of the two-layer mold. Thus, an over-cladding portion was formed on the outermost periphery. The molten resin discharged from the mold was taken up to obtain an unstretched GI type POF (preform) having a core portion diameter of 200 μm, a cladding portion diameter of 280 μm, and an outer diameter of 750 μm.

The obtained preform was allowed to cool, and was then stretched at 1.12 times in an oven at 80° C. (Tg of the above-mentioned PC−40° C.) at a stretching speed of 0.1 m/min to obtain the POF of this Example. The birefringence Δn of the over-cladding portion of the obtained POF was 0.015. The obtained POF was subjected to the evaluation in the section (2). The result is shown in Table 1.

### Example 2

A POF was obtained in the same manner as in Example 1 except that the stretching ratio was changed from 1.12 times to 1.10 times. The birefringence Δn of the over-cladding portion of the obtained POF was 0.007. The obtained POF was subjected to the same evaluation as that in Example 1. The result is shown in Table 1.

### Example 3

A POF was obtained in the same manner as in Example 2 except that the stretching temperature was changed from 80° C. to 110° C. (Tg of the above-mentioned PC−10° C.). The birefringence Δn of the over-cladding portion of the obtained POF was 0.006. The obtained POF was subjected to the same evaluation as that in Example 1. The result is shown in Table 1.

### Example 4

A POF was obtained in the same manner as in Example 2 except that the stretching temperature was changed from 80° C. to 70° C. (Tg of the above-mentioned PC−50° C.). The birefringence Δn of the over-cladding portion of the obtained POF was 0.005. The obtained POF was subjected to the same evaluation as that in Example 1. The result is shown in Table 1.

### Example 5

A POF was obtained in the same manner as in Example 2 except that the stretching temperature was changed from 80° C. to 130° C. (Tg of the above-mentioned PC+10° C.). The birefringence Δn of the over-cladding portion of the obtained POF was 0.0025. The obtained POF was subjected to the same evaluation as that in Example 1. The result is shown in Table 1.

### Comparative Example 1

A POF was obtained in the same manner as in Example 2 except that the stretching temperature was changed from 80° C. to 170° C. (Tg of the above-mentioned PC+50° C.). The birefringence Δn of the over-cladding portion of the obtained POF was 0.0008. The obtained POF was subjected to the same evaluation as that in Example 1. The result is shown in Table 1.

### Comparative Example 2

The preform of Example 1 was used directly as a POF (that is, stretching was not performed). The birefringence Δn of the over-cladding portion of the POP was 0.0007. The POF was subjected to the same evaluation as that in Example 1. The result is shown in Table 1.

### Comparative Example 3

A POF was obtained in the same manner as in Example 2 except that the stretching temperature was changed from 80° C. to 140° C. (Tg of the above-mentioned PC 20° C.). The birefringence Δn of the over-cladding portion of the obtained POF was 0.0015. The obtained POF was subjected to the same evaluation as that in Example 1. The result is shown in Table 1.

### Comparative Example 4

An attempt was made to produce a POF in the same manner as in Example 1 except that the stretching temperature was changed from 80° C. to 70° C. (Tg of the above-mentioned PC−50° C.). However, the preform was broken, and no POF was obtained.

TABLE 1

| | Stretching | Stretching | | Solvent | |
|---|---|---|---|---|---|
| | tempera- | ratio | | crack | |
| | ture (° C.) | (times) | Δn | resistance | Remark |
| Example 1 | 80 | 1.12 | 0.015 | 1 month or | |
| | | | | more | |
| Example 2 | 80 | 1.10 | 0.007 | 1 week or | |
| | | | | more and | |
| | | | | less than | |
| | | | | 1 month | |
| Example 3 | 110 | 1.10 | 0.006 | 1 week or | |
| | | | | more and | |
| | | | | less than | |
| | | | | 1 month | |
| Example 4 | 70 | 1.10 | 0.005 | 1 week or | |
| | | | | more and | |
| | | | | less than | |
| | | | | 1 month | |
| Example 5 | 130 | 1.10 | 0.0025 | 1 week or | |
| | | | | more and | |
| | | | | less than | |
| | | | | 1 month | |
| Comparative | 170 | 1.10 | 0.0008 | Less than | |
| Example 1 | | | | 10 minutes | |
| Comparative | — | — | 0.0007 | Less than | Un- |
| Example 2 | | | | 10 minutes | stretched |
| Comparative | 140 | 1.10 | 0.0015 | Less than | |
| Example 3 | | | | 30 minutes | |
| Comparative | 70 | 1.12 | — | — | Impossible |
| Example 4 | | | | | to evaluate |
| | | | | | due |
| | | | | | to breakage |

### EVALUATION

As is apparent from the results of Examples and Comparative Examples, it is understood that each of the POFs of Examples of the present invention has dramatically improved solvent crack resistance as compared to those of Comparative Examples. That is, cracks do not occur even when each of the POFs of Examples of the present invention is used for a long period of time in a state of being bent (having an external force applied thereto) and being brought into contact with a hydrocarbon-based solvent.

### INDUSTRIAL APPLICABILITY

The plastic optical fiber of the present invention is useful as a constituent element of an optical fiber cable intended for high-speed communication. Further, through a change in shape, the plastic optical fiber of the present invention can be applied as optical members including: photoconductive elements, such as optical waveguides; lenses for still cameras, video cameras, telescopes, eyeglasses, plastic contact lenses, and sunlight condensing; mirrors, such as concave mirrors and polygon mirrors; and prisms, such as pentaprisms.

### REFERENCE SIGNS LIST

10 plastic optical fiber (POF)
12 core portion
14 cladding portion
16 over-cladding portion

1. A plastic optical fiber, comprising:
a core portion;
a cladding portion arranged on an outer periphery of the core portion; and
an over-cladding portion arranged on an outer periphery of the cladding portion,
wherein the over-cladding portion has a birefringence Δn of 0.002 or more.

2. The plastic optical fiber according to claim 1, wherein the over-cladding portion contains a polycarbonate-based resin.

3. The plastic optical fiber according to claim 1, wherein the plastic optical fiber is prevented from causing cracks after having been left for 1 week in a state of being bent with a radius of curvature of 20 mm and being brought into contact with polyethylene glycol or a long-chain aliphatic hydrocarbon.

4. A method of producing the plastic optical fiber of claim 1, comprising:
forming a preform; and
stretching the preform,
wherein a stretching ratio of the stretching is 1.2 times or less, and a stretching temperature thereof is less than a glass transition temperature of the over-cladding portion.

5. A plastic optical fiber cord, comprising the plastic optical fiber of claim 1.
